(19) United States
(12) Patent Application Publication
(10) Pub. No.: US 2026/0277464 A1
(43) Pub. Date: Sep. 17, 2026

(54) APPARATUS WITH TEMPERATURE-BASED MANAGEMENT MECHANISM AND METHODS FOR OPERATING THE SAME

(71) Applicant: Micron Technology, Inc., Boise, ID (US)

(72) Inventor: Xiaoyang Wang, Shanghai (CN)

(21) Appl. No.: 19/533,081

(22) Filed: Feb. 6, 2026

Related U.S. Application Data
(60) Provisional application No. 63/772,345, filed on Mar. 14, 2025.

(51) Int. Cl. G06F 3/06

(52) U.S. Cl. CPC G06F 3/0653; G06F 3/0617; G06F 3/0683

(57) ABSTRACT

Disclosed herein are methods, apparatuses and systems related to detecting and managing erroneous temperature readings during operations. The apparatus may be configured to obtain prior operating temperature readings. When the obtained temperature reading satisfies an initial trigger, the apparatus may determine a synthetic temperature reading based on the prior temperature readings, outputs of other sensors, or a combination thereof.

### CROSS-REFERENCE TO RELATED APPLICATIONS

The present application claims priority to U.S. Provisional Patent Application No. 63/772,345, filed Mar. 14, 2025, the disclosure of which is incorporated herein by reference in its entirety.

### TECHNICAL FIELD

The disclosed embodiments relate to devices, and, in particular, to semiconductor memory devices with temperature-based management mechanism and methods for operating the same.

### BACKGROUND

Memory systems can employ memory devices to store and access information. The memory devices can include volatile memory devices, non-volatile memory devices (e.g., flash memory employing “NAND” technology or logic gates, “NOR” technology or logic gates, or a combination thereof), or a combination device. The memory devices utilize electrical energy, along with corresponding threshold levels or processing/reading voltage levels, to store and access data. However, the performance or characteristics of the memory devices can be affected by ambient temperatures.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure.

FIG. 1 is a block diagram of a computing system in accordance with an embodiment of the present technology.

FIG. 2 is an illustration of a temperature management mechanism in accordance with an embodiment of the present technology.

FIG. 3 is a flow diagram illustrating an example method of operating an apparatus in accordance with an embodiment of the present technology.

FIG. 4 is a schematic view of a system that includes an apparatus in accordance with an embodiment of the present technology.

### DETAILED DESCRIPTION

As described in greater detail below, the technology disclosed herein relates to an apparatus, such as memory systems, systems with memory devices, related methods, etc., for evaluating valid memory operating conditions based on reference temperature information. For example, a memory system can approximate local temperature conditions based on historical temperature data and/or predetermined lookup values and adjust internal memory operations accordingly.

The memory system can be implemented within a variety of larger/encompassing devices or systems. Accordingly, the deployed operating environment and the corresponding effects on the memory system’s performance can differ vastly across applications. One such environmental condition can include ambient temperature. The ambient temperature affects the operating temperature of the memory system, thereby affecting operating performance. For example, changes in the system temperature can affect the threshold voltage of memory cells due to the influence of temperature on the physical characteristics of the materials used in the memory cells. As the temperature changes, the conductivity and other electrical properties of the memory cells can also change. As a result, some precautionary implementations of the memory system disable memory functionality in response to detecting an exceedingly high operating temperature (e.g., above 110 ºC).

However, the memory system may encounter an abnormal, or invalid, output readings from temperature sensing circuits. For example, the memory system may receive a designated null value (e.g., 0xFF) that corresponds to a corrupted temperature reading.

To avoid automatic disablement of memory operations in response to the erroneous readings and intelligently adapt to occasional temperature read errors, embodiments of the technology described herein can include a temperature-based management mechanism that computes and/or predicts a synthetic substitute temperature reading. For example, the temperature management mechanism can retrieve historical temperatures (e.g., previous operating temperature readings) and/or predetermined reference temperatures (e.g., a lookup table) stored on a running window, or buffer, of the memory array. Based on the prior and/or reference temperature readings, the memory system can approximate the current operating temperature and implement necessary adjustments to memory operations accordingly (e.g., pausing memory functionality or continuing operation with or without temperature-based adjustments).

Accordingly, the temperature management mechanism using the prior and/or the reference temperatures readings in response to a targeted temperature pattern can provide reliable estimates of operating temperatures for the memory system. The approximated temperature values enable the memory system to maintain memory operability while adhering to existing failsafe procedures, which can lower overall memory errors/failures, reduce remedial operations, along with other benefits. For example, the memory system can use the predicted temperature reading to determine whether the operating environment presents acceptable conditions for memory operations, which would otherwise have been terminated automatically.

### Example Environment

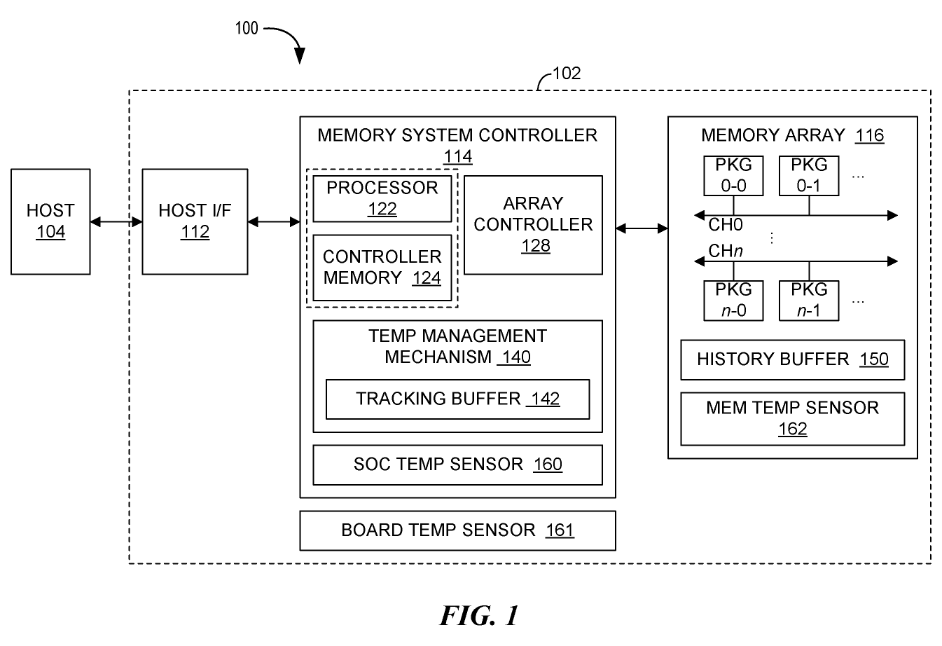

FIG. 1 is a block diagram of a computing system 100 in accordance with an embodiment of the present technology. The computing system 100 can include a personal computing device/system, an enterprise system, a mobile device, a server system, a database system, a distributed computing system, a system management device (e.g., a vehicle management device), or the like.

The computing system 100 can have a memory system 102 coupled to a host device 104. The host device 104 can include one or more system processors that can write data to and/or read data from the memory system 102. For example, the host device 104 can include an upstream central processing unit (CPU). Also, for example, the host device 104 can be configured to control operation of a corresponding structure or system, such as other components (not shown) of the computing system 100 or structures operably coupled to the computing system.

The memory system 102 can include circuitry configured to store data (via, e.g., write operations) and provide access to stored data (via, e.g., read operations). For example, the memory system 102 can include a persistent or non-volatile data storage system, such as a NAND-based Flash drive system, an SSD system, an SD card, or the like.

The memory system 102 can include a host interface 112 (e.g., buffers, transmitters, receivers, and/or the like) configured to facilitate communications with the host device 104. The host interface 112 can be configured to support one or more host interconnect schemes, such as Universal Serial Bus (USB), Peripheral Component Interconnect (PCI), Serial AT Attachment (SATA), or the like. The host interface 112 can receive commands, addresses, data (e.g., write data), and/or other information from the host device 104. The host interface 112 can also send data (e.g., read data) and/or other information to the host device 104. In some embodiments, the host interface 112 can be configured to implement the UFS protocols in communicating with the host device 104.

The memory system 102 can further include a memory system controller 114 (also called a micro controller) and a memory array 116. The memory array 116 can include memory cells that are configured to store a unit of information. The memory system controller 114 can be configured to control the overall operation of the memory system 102, including the operations of the memory array 116.

In some embodiments, the memory array 116 can include a set of NAND Flash devices, packages, dies, or the like. Each of the packages can include a set of memory cells that each store data in a charge storage structure. The memory cells can include, for example, floating gate, charge trap, phase change, ferroelectric, magnetoresitive, and/or other suitable storage elements configured to store data persistently or semi-persistently. The memory cells can be one-transistor memory cells that can be programmed to a target state to represent information. For instance, electric charge can be placed on, or removed from, the charge storage structure (e.g., the charge trap or the floating gate) of the memory cell to program the cell to a particular data state. The stored charge on the charge storage structure of the memory cell can indicate the Vt of the cell. For example, a single level cell (SLC) can be programmed to a targeted one of two different data states, which can be represented by the binary units 1 or 0. Also, some flash memory cells can be programmed to a targeted one of more than two data states. Multilevel cells (MLCs) may be programmed to any one of four data states (e.g., represented by the binary 00, 01, 10, 11) to store two bits of data. Similarly, triple level cells (TLCs) may be programmed to one of eight (i.e., 2³) data states to store three bits of data, and quad level cells (QLCs) may be programmed to one of 16 (i.e., 2⁴) data states to store four bits of data.

Such memory cells may be arranged in rows (e.g., each corresponding to a word line 143) and columns (e.g., each corresponding to a bit line). The arrangements can further correspond to different groupings for the memory cells. For example, each word line can correspond to one or more memory pages. Also, the memory array 116 can include memory blocks that each include a set of memory pages. In operation, the data can be written or otherwise programmed (e.g., erased) with regards to the various memory regions of the memory array 116, such as by writing to groups of pages and/or memory blocks. In NAND-based memory, a write operation often includes programming the memory cells in selected memory pages with specific data values (e.g., a string of data bits having a value of either logic 0 or logic 1). An erase operation is similar to a write operation, except that the erase operation re-programs an entire memory block or multiple memory blocks to the same data state (e.g., logic 0).

While the memory array 116 is described with respect to the memory cells, it is understood that the memory array 116 can include other components (not shown). For example, the memory array 116 can also include other circuit components, such as multiplexers, decoders, buffers, read/write drivers, address registers, data out/data in registers, etc., for accessing and/or programming (e.g., writing) the data and for other functionalities.

As described above, the memory system controller 114 can be configured to control the operations of the memory array 116. The memory system controller 114 can include a processor 122, such as a special purpose logic circuitry (e.g., a field programmable gate array (FPGA), an application specific integrated circuit (ASIC), etc.), a microprocessor, or other suitable processor. The processor 122 can execute instructions encoded in hardware, firmware, and/or software (e.g., instructions stored in controller embedded memory 124) to execute various processes, logic flows, and routines for controlling operation of the memory system 102 and/or the memory array 116.

Further, the memory system controller 114 can further include an array controller 128 that controls or oversees detailed or targeted aspects of operating the memory array 116. For example, the array controller 128 can provide a communication interface between the processor 122 and the memory array 116 (e.g., the components therein). The array controller 128 can function as a multiplexer/demultiplexer, such as for handling transport of data along serial connection to flash devices in the memory array 116.

The memory system 102 can further include one or more sensors (e.g., an internal temperature sensor) that observe/measure operating conditions in real-time. Some examples of the internal temperatures sensor can include (1) a controller (e.g., a system-on-chip (SOC)) temperature sensor 160 located within and configured to measure the operating temperature of the memory system controller 114, (2) a board temperature sensor 161 located on a printed circuit board (PCB) having the controller 114 mounted thereon and configured to measure the operating temperature at the PCB (e.g., an ambient temperature for the controller 114), and/or (3) a memory temperature sensor 162 located within and configured to measure the operating temperature of the memory array 116 or the packages therein (e.g., the NAND chips). The memory system 102 can receive outputs from the internal temperature sensor according to a predetermined schedule and/or a trigger. The memory system 102 can further adapt internal operations, such as by using different trim settings to adjust the threshold voltages, according to the internal operating temperature of the memory system 102 as provided by the internal temperature sensor.

The memory system 102 can include a temperature management mechanism 140 (e.g., software instructions, firmware, dedicated circuit, or the like) configured to adapt and manage internal operations of the memory system 102 according to temperature information. As an illustrative example, the memory system 102 can be configured to detect and manage erroneous temperature readings from the internal temperature sensor. The temperature management mechanism 140 can be configured to enable/disable memory operations on the memory array 116 according to the determination of whether the internal temperature sensor outputs are accurate or erroneous.

In some cases, the memory system 102 may determine that a receive temperature reading (e.g., an error code, a null signal, etc.) is abnormal, such as using predetermined patters (e.g., all ‘0’s or all ‘1’s) or a threshold that represents a highly unlikely operating condition (e.g., a temperature that will cause physical damage to the memory system 102). For such events, the temperature management mechanism 140 can be configured to use historical temperature readings, readings from other sensors, recent readings, or a combination thereof to approximate an expected or an actual temperature value. Based on the approximated temperature reading, the context management mechanism 140 can control memory operations performed on the memory array 116. For example, the temperature management mechanism 140 can pause and/or terminate memory operations for the memory array 116 when the approximated temperature reading is not within an acceptable temperature range (e.g., below 110 ºC). For the approximation, the temperature management mechanism 140 can be configured to utilize a tracking buffer 142, such as for a running window of recent temperature readings, or history buffer 150 that logs the previous erred sensor outputs and corresponding approximation values.

As an example, the temperature management mechanism 140 can be detect and manage an erroneous output from the board temperature sensor 161. In some conventional systems, a temperature reading from board sensor that is beyond an operating threshold can indicate a catastrophic failure (e.g., discarding the corresponding memory device). However, board sensors may occasionally provide erroneous outputs, such as due to sensor-internal issues and/or due to signal noise. To prevent triggering the catastrophic failure in response to such erroneous sensor outputs, the temperature management mechanism 140 can determine the validity of the sensor outputs using historical data from the history buffer 150, recent readings from the board temperature sensor 161, current readings from the SOC temperature sensor 160/memory temperature sensor 162, or a combination thereof.

For illustrative purposes, the tracking buffer 142 is shown implemented at the controller 114 and the history buffer 150 at the memory array 116. However, it is understood that the tracking buffer 142 and the history buffer 150 can be implemented at the controller 114 or the array 116.

### Synthetic Evaluations

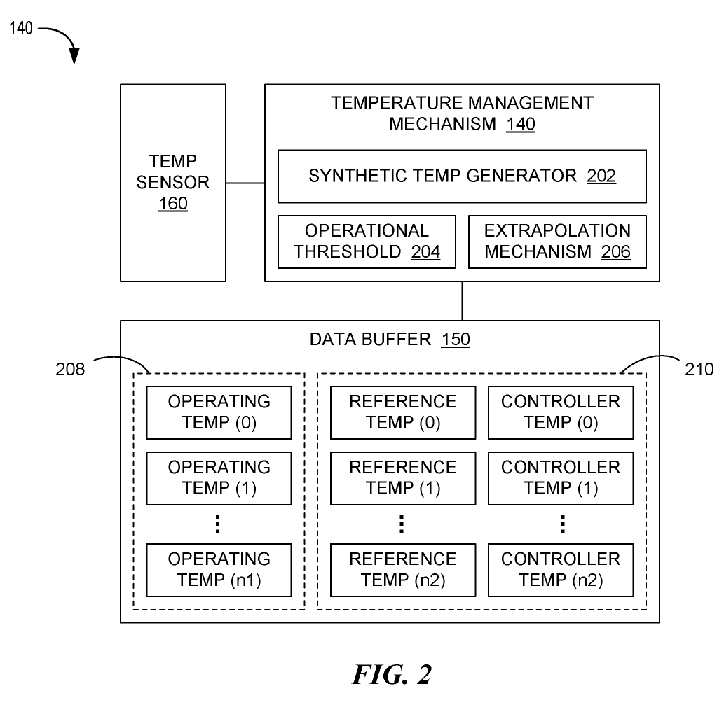

FIG. 2 is an illustration of a temperature management mechanism (e.g., the temperature management mechanism 140) in accordance with an embodiment of the present technology. As shown in FIG. 2, the temperature management mechanism 140 (alternatively referred to as “mechanism 140”) can be communicatively coupled with the internal temperature sensor 160 of the memory system 102 and the history buffer 150 of the memory array 116. The mechanism 140 can also include a synthetic temperature generator 202, an operational threshold 204, and an extrapolation mechanism 206.

The mechanism 140 can be configured to continuously receive operating temperature readings from the temperature sensor (e.g., from the SOC temperature sensor 160, the board temperature sensor 161, and/or the memory temperature sensor 162 illustrated in FIG. 1). The mechanism 140 can be configured to compare the obtained operating temperature readings to the operational threshold 204 (e.g., all ‘0’s, all ‘1’s, and/or highly unlikely temperature described above, such as 110 ºC or greater) to determine whether the memory system 102 is operating under acceptable temperatures.

When the controller 114 receives a temperature reading from a temperature sensor, the mechanism 140 can compare the data to the threshold and/or one or more predetermined patterns to determine that the reading is abnormal. When the received values are within an acceptable range (e.g., below the threshold and outside of any patterns), the controller 114 can store the received reading in the tracking buffer 142. The tracking buffer 142 can be configured as a running window that tracks the most recent n number of readings. The tracking buffer 142 can be used to track the most recent set of readings from the SOC temperature sensor 160, the board temperature sensor 161, and/or the memory temperature sensor 162.

When the received values are outside of the acceptable range, the mechanism 140 can use the synthetic temperature generator 202 to estimate a proper temperature reading based on the recent set of readings and/or historical temperature readings stored in the history buffer 150. The history buffer 150 can be configured to store a history of operating temperature readings received from the temperature sensor 160, such as previous erroneous readings and the corresponding approximations. For example, the history buffer 150 can include an operating temperature history 208 that represents a time-ordered sequence of temperature readings that are evaluated by the mechanism 140. The synthetic temperature generator 202 can use the extrapolation mechanism 206 to fit the prior temperature readings of the operating temperature history 208 to a statistical trend model (e.g., a linear projection). The extrapolation mechanism 206 can include one or more predetermined processes (e.g., software instructions, equations, etc.) for determining a trend from existing data, such as the past readings in the tracking buffer 142, and predicting the next data point. Accordingly, the synthetic temperature generator 202 can use the trend model to predict an approximate temperature value to replace the invalid operating temperature reading.

In some embodiments, the history buffer 150 can be configured to store predetermined relationships between temperature values obtainable from the temperature sensor 160. For example, the history buffer 150 can include a stored mapping 210 (e.g., a lookup table) that relates a primary temperature value (e.g., an operating temperature reading from the board temperature sensor 161) to a secondary temperature value (e.g., a controller temperature reading), and vice versa. Accordingly, the synthetic temperature generator 202 can index the stored mapping 210 using a sample temperature reading of the memory system controller 114 to determine a corresponding reference temperature value. As a result, the mechanism 140 can compare the identified reference temperature to the operational threshold 204 to determine whether the memory system 102 is operating under acceptable temperatures. The mechanism 140 can use the reading from the SOC temperature sensor 160 and/or the memory temperature sensor 162 to approximate the environmental temperature that would correspond to a more accurate (e.g., non-erroneous) output from the board temperature sensor 161. Also, the mechanism 140 can store records of previous erroneous readings (e.g., the otherwise catastrophic reading from the board temperature sensor 161) with corresponding previous approximations.

### Control Flow

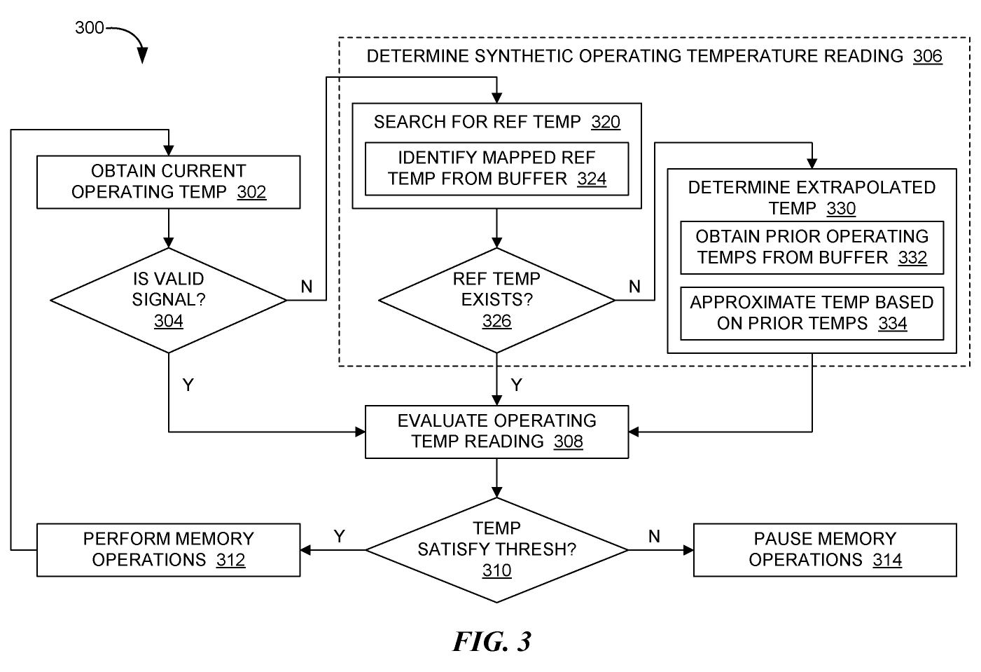

FIG. 3 is a flow diagram illustrating an example method 300 of operating an apparatus (e.g., the memory system 102 of FIG. 1 or one or more components therein) in accordance with an embodiment of the present technology. The example methods can be for implementing the temperature management mechanism 140 of FIG. 1.

At block 302, the memory system 102 can obtain a current operating temperature reading (e.g., of the memory system 102) from the temperature sensor. For example, the memory system 102 can probe one or more internal temperature sensing circuits, such as the board temperature sensor 161 of FIG. 1, the SOC temperature sensor 160 of FIG. 1, and/or the memory temperature sensor 162 of FIG. 1, to obtain a real-time temperature output reading of the system 102, or individual components thereof. The obtained temperature output reading can have a timestamp corresponding to the datetime the memory system 102 receives the reading from the temperature sensor 160.

The memory system 102 can obtain the current operating temperature reading according to a predetermined frequency (e.g., every n seconds, every m milliseconds, etc.). In some embodiments, the memory system 102 can be configured to obtain the current operating temperature reading according to a dynamic frequency based on prior obtained operating temperature readings. For example, the memory system 102 can re-probe, or refresh, for the current operating temperature reading at a lower frequency rate (e.g. or higher frequency rate) when the previously obtained operating temperature reading(s) are within a lower temperature range (e.g. or higher temperature range).

At decision block 304, the memory system 102 can validate the current operating temperature reading obtained from the temperature sensor. For example, the memory system 102 can compare the obtained operating temperature reading to predetermined output conditions (e.g., designated error codes, outside practical temperature range(s), corrupted data values, etc.) that correspond to invalid return signals for the temperature sensor 160. In some embodiments, the memory system 102 can compare the temperature reading to a predetermined threshold that corresponds to an upper end of the operating range, the physically damaging scenario, and/or the like. In response to determining a valid output reading, the memory system 102 can store the current operating temperature reading within the tracking buffer 142 of FIG. 1 of the memory array 116 for further evaluation as illustrated in block 308. Otherwise, when the temperature reading is not valid (e.g., outside of the operating range or above the damaging threshold) the memory system 102 can replace an invalid current operating temperature reading with a synthetic operating temperature reading as illustrated in block 306.

At block 306, the memory system 102 can determine a synthetic operating temperature reading based on historical operating temperature readings recorded on the history buffer 150 of FIG. 1 and/or the tracking buffer 142. The synthetic operating temperature reading represents a proxy measurement for invalid operating temperature readings obtained from the temperature sensor 160.

In some embodiments, the memory system 102 can search the history buffer 150 for a stored reference temperature (e.g., a previous fail record having the invalid temperature reading matching the current invalid temperature reading) that is appropriate for the synthetic operating temperature reading, as illustrated in block 320. For example, the memory system 102 can access a stored mapping 210 (e.g., a set of key-value pairs, a lookup table, a reference chart, etc.) from the history buffer 150 that relates reference operating temperature readings (e.g., primary temperature reading or past recorded erroneous readings) to controller temperature readings (e.g., secondary temperature reading or past corresponding extrapolated temperatures). As a result, the memory system 102 can attempt to identify a reference operating temperature reading from the stored mapping 210 that corresponds to the current controller temperature reading, as illustrated in block 324. Thus, the memory system 102 can use the identified reference operating temperature reading as the synthetic operating temperature reading.

In some embodiments, the memory system 102 can store a static (e.g. immutable) mapping 210 of reference operating temperature readings and controller temperature readings within the history buffer 150. For example, the memory system 102 can encode a predetermined set of key (e.g. controller temperature reading) and value (e.g., reference operating temperature reading) pairs into the history buffer 150 prior to initialization of the memory apparatus and/or components thereof. Additionally, or alternatively, the memory system 102 can store a dynamic (e.g. mutable) mapping 210 of reference operating temperature readings and controller temperature readings within the history buffer 150. For example, the memory system 102 can insert the current operating temperature reading (e.g. or the determined synthetic operating temperature reading) and the current controller temperature reading into the stored mapping 210 as a new key-value pair. In some embodiments, the memory system 102 can dynamically insert new key-value pairs into a stored mapping 210 of the history buffer 150 that is initialized with a predetermined mapping between reference operating temperature readings and controller temperature readings.

The memory system 102 can obtain the current operating temperature reading (e.g., of the memory system 102) and the current controller temperature reading (e.g., of the memory system controller 114) in a parallel operation such that both temperature readings correspond to the same (e.g. or similar) timestamp. For example, the memory system 102 can obtain the current controller temperature reading along with the current operating temperature reading from the temperature sensor 160 at block 302.

For illustrative purposes, the embodiments described herein pertain to mapping temperature readings of the memory system controller 114 to temperature readings of the memory system 102. However, an ordinary person skilled in the art will appreciate that the described embodiments are applicable to any proxy measurements that are correlated to the operating temperature of the memory system 102, such as the temperature readings of the memory array 116.

At decision block 326, the memory system 102 can evaluate the existence of a reference operating temperature reading stored in the history buffer 150. As described above with respect to blocks 320 and 324, the memory system 102 can perform a search within the stored mapping 210 of the history buffer 150 for an existing reference operating temperature reading that maps to the current controller temperature reading (e.g., of the memory system controller 114). In response to a successful identification (e.g., when the reference temperature exists, such as previous matching failure), the memory system 102 can obtain the recorded reference operating temperature reading (e.g., synthetic operating temperature reading) within the history buffer 150 of the memory array 116 for further evaluation as illustrated in block 308.

When the reference temperature does not exist, the memory system 102 can approximate a synthetic operating temperature reading based on records of historical operating temperature readings. In some embodiments, the memory system 102 can determine an extrapolated operating temperature reading for the synthetic operating temperature reading, as illustrated in block 330. For example, at block 332, the memory system 102 can obtain one or more previous operating temperature readings (e.g., n records of prior operating temperature readings) from the tracking buffer 142. Using the extrapolation mechanism 206, the memory system 102 can numerically fit the previous operating temperature readings to a statistical trend model (e.g., linear regression, parabolic regression, statistical average, etc.) that predicts an expected, or an approximate, temperature value for the current operating temperature reading. The memory system 102 can store the approximated temperature value (e.g., synthetic operating temperature reading) within the history buffer 150 for further evaluation as illustrated in block 308. Accordingly, when the sensor provides the same erroneous value, the memory system 102 can recall the approximation without accessing the tracking buffer 142 at that time and without reperforming the computation process.

In some embodiments, the memory system 102 can transition directly to block 330 in response to determining an invalid signal for the current operating temperature reading at block 304 (e.g., skipping operations described in blocks 320, 324, and 326). Accordingly, the memory system 102 may be configured to only store the operating temperature history 208 at the history buffer 150 (e.g., without storing the mapping 210 between reference operating temperature readings and controller temperature readings), and thus reducing overhead usage of the memory array 116.

The memory system 102 can evaluate a subset of the previous operating temperature readings to approximate the synthetic operating temperature reading. For example, the memory system 102 can predict the synthetic operating temperature based on a fitted trend model that uses the n most recent prior operating temperature readings stored in the tracking buffer 142. In another example, the memory system 102 can predict the synthetic operating temperature based on a fitted trend model that uses every nth prior operating temperature reading to minimize effects of transient noise (e.g., reducing impact of volatile temperature reading sequences). An ordinary person skilled in the art will appreciate that the foregoing examples are not limiting and that the memory system 102 can fit the trend model using alternative combinations (e.g., randomized groupings, custom measurement sequences, etc.) of the previous temperature readings that may not be explicitly discussed herein.

At block 308, the memory system 102 can evaluate the operating temperature reading obtained from blocks 304, 326, or 330. For example, the memory system 102 can compare the operational temperature reading to an operational threshold representing acceptable temperature values for performing memory operations (e.g., read, write, validate, etc.) on the memory array 116. In some embodiments, the operational threshold can correspond to a numerical range of acceptable temperature values (e.g., less than 110 ºC). In some embodiments, the memory system 102 can insert the operating temperature reading obtained from blocks 304, 326, or 330 to the operating temperature history 208 with a corresponding timestamp.

When the operating temperature reading fails to satisfy the operational threshold (e.g., not within acceptable temperature range), the memory system 102 can initiate a pause of memory operations (e.g., current and/or requested operations) for the memory array 116, as illustrated in block 314. In some embodiments, the memory system 102 can disable a connection with the host device 104 from communicating with the memory array 116 when pausing the memory operations. Additionally, or alternatively, the memory system 102 can transmit a message to the host device 104 indicating the corresponding error condition (e.g., the catastrophic). As an illustrative example, when the board temperature sensor 161 provides an invalid value, the mechanism 140 can verify that such value was valid and not provided in error through blocks 320-334 before pausing the memory operations.

When the operating temperature reading satisfies the operational threshold (e.g., within acceptable temperature range), the memory system 102 can enable execution of memory operations on the memory array 116, as illustrated in block 312. For example, the memory system 102 can read and transmit data stored at select memory cells to a host device 104 while the operating temperature reading satisfies the operational threshold. The memory system 102 can continuously obtain and evaluate the operating temperature readings as illustrated by the feedback loop to block 302. Continuing with the illustrative example, when the board temperature sensor 161 provides an invalid value, the mechanism 140 can detect the invalid value as an erroneous value and compute the approximation for the actual condition. Moreover, the mechanism 140 can evaluate the approximation instead of the provided erroneous value, thereby avoiding an unnecessary pause in the memory operations.

### Overall System

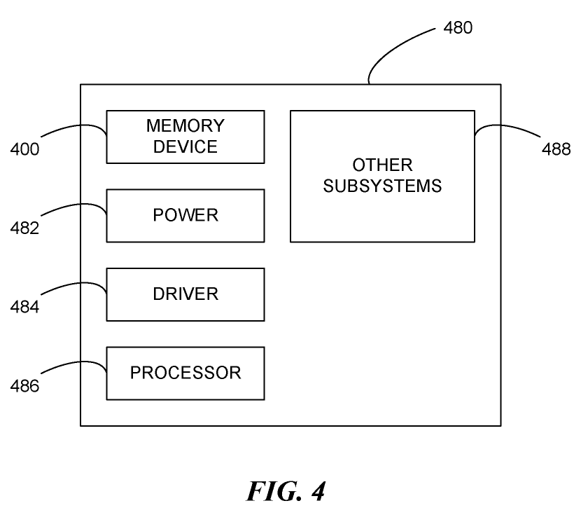

FIG. 4 is a schematic view of a system that includes an apparatus in accordance with embodiments of the present technology. Any one of the foregoing apparatuses (e.g., memory devices) described above with reference to FIGS. 1-3 can be incorporated into any of a myriad of larger and/or more complex systems, a representative example of which is system 480 shown schematically in FIG. 4. The system 480 can include a memory device 400, a power source 482, a driver 484, a processor 486, and/or other subsystems or components 488. The memory device 400 can include features generally similar to those of the apparatus described above with reference to one or more of the FIGS, and can therefore include various features for performing a direct read request from a host device. The resulting system 480 can perform any of a wide variety of functions, such as memory storage, data processing, and/or other suitable functions. Accordingly, representative systems 480 can include, without limitation, hand-held devices (e.g., mobile phones, tablets, digital readers, and digital audio players), computers, vehicles, appliances and other products. Components of the system 480 may be housed in a single unit or distributed over multiple, interconnected units (e.g., through a communications network). The components of the system 480 can also include remote devices and any of a wide variety of computer readable media.

From the foregoing, it will be appreciated that specific embodiments of the technology have been described herein for purposes of illustration, but that various modifications may be made without deviating from the disclosure. In addition, certain aspects of the new technology described in the context of particular embodiments may also be combined or eliminated in other embodiments. Moreover, although advantages associated with certain embodiments of the new technology have been described in the context of those embodiments, other embodiments may also exhibit such advantages and not all embodiments need necessarily exhibit such advantages to fall within the scope of the technology. Accordingly, the disclosure and associated technology can encompass other embodiments not expressly shown or described herein.

In the illustrated embodiments above, the apparatuses have been described in the context of NAND Flash devices. Apparatuses configured in accordance with other embodiments of the present technology, however, can include other types of suitable storage media in addition to or in lieu of NAND Flash devices, such as, devices incorporating NOR-based non-volatile storage media (e.g., NAND flash), magnetic storage media, phase-change storage media, ferroelectric storage media, dynamic random access memory (DRAM) devices, etc.

The term "processing" as used herein includes manipulating signals and data, such as writing or programming, reading, erasing, refreshing, adjusting or changing values, calculating results, executing instructions, assembling, transferring, and/or manipulating data structures. The term data structure includes information arranged as bits, words or code-words, blocks, files, input data, system-generated data, such as calculated or generated data, and program data. Further, the term "dynamic" as used herein describes processes, functions, actions or implementation occurring during operation, usage, or deployment of a corresponding device, system or embodiment, and after or while running manufacturer's or third-party firmware. The dynamically occurring processes, functions, actions or implementations can occur after or subsequent to design, manufacture, and initial testing, setup or configuration.

The above embodiments are described in sufficient detail to enable those skilled in the art to make and use the embodiments. A person skilled in the relevant art, however, will understand that the technology may have additional embodiments and that the technology may be practiced without several of the details of the embodiments described above with reference to one or more of the FIGS. described above.

### Further Examples

In some embodiments, the techniques described herein relate to a memory device, that includes a memory array having memory cells configured to store data, an internal sensor configured to provide operating temperature readings of the memory device, and a memory controller operably coupled to the memory array and the internal sensor. In some embodiments, the memory controller is configured to obtain a current operating temperature reading, determine a synthetic operating temperature reading based on prior operating temperature readings when the current operating temperature reading corresponds to an invalid signal, and perform memory operations on the memory array when the synthetic operating temperature reading satisfies an operational threshold for acceptable operating temperature readings of the memory device.

In some embodiments, the memory device includes a data buffer of the memory array stores the prior operating temperature readings of the memory device.

In some embodiments, the data buffer of the memory array is configured to store the prior operating temperature readings in an ordered sequence according to corresponding timestamps.

In some embodiments, the memory controller is further configured to determine an approximate operating temperature reading for the synthetic operating temperature reading by extrapolating the ordered sequence of prior operating temperature readings.

In some embodiments, the extrapolation of the ordered sequence of prior operating temperature readings is performed using a linear regression model.

In some embodiments, the memory controller is further configured to store the current operating temperature reading in the data buffer of the memory array when the current operating temperature reading satisfies the operational threshold.

In some embodiments, the memory controller is further configured to store the synthetic operating temperature reading in the data buffer of the memory array.

In some embodiments, the memory device includes a data buffer of the memory array that stores a mapping of controller temperature readings to reference operating temperature readings. In some embodiments, the memory controller is further configured to obtain a current controller temperature reading of the memory controller and assign the synthetic operating temperature reading to a reference operating temperature reading that is mapped to the current controller temperature reading in the data buffer.

In some embodiments, the data buffer stores predetermined mappings of controller temperature readings to reference operating temperature readings.

In some embodiments, the memory controller is further configured to add a mapping between the current controller temperature reading and the current operating temperature reading into the data buffer.

In some embodiments, the memory controller is further configured to pause memory operations on the memory array when the synthetic operating temperature reading fails to satisfy the operational threshold.

In some embodiments, the operational threshold for acceptable operating temperature readings of the memory device is less than 110 degrees Celsius.

In some embodiments, the data buffer of the memory array is configured to store up to n operating temperature readings.

We claim:

1. A memory device, comprising:
a memory array having memory cells configured to store data;
a board sensor configured to provide operating temperature readings of the memory device; and
a memory controller operably coupled to the memory array and the board sensor, the memory controller configured to:
obtain a current operating temperature reading from the board sensor, wherein the current operating temperature fails the operational threshold;
compute a synthetic operating temperature reading based on prior operating temperature readings when the current operating temperature reading corresponds to an invalid signal, wherein the synthetic operating temperature reading represents an approximation of the current operating temperature; and
perform memory operations on the memory array when the synthetic operating temperature reading satisfies an operational threshold for acceptable operating temperature readings of the memory device.

2. The memory device of claim 1, wherein the memory controller includes a tracking buffer of the memory array configured to store the prior operating temperature readings from the board sensor.

3. The memory device of claim 2, wherein the data buffer of the memory array is configured to store the prior operating temperature readings in an ordered sequence according to corresponding timestamps.

4. The memory device of claim 3, wherein the memory controller is further configured to:
compute the synthetic operating temperature reading by extrapolating the synthetic operating temperature reading from the ordered sequence of the prior operating temperature readings.

5. The memory device of claim 4, wherein the extrapolation of the ordered sequence of prior operating temperature readings is performed using a linear fitting model.

6. The memory device of claim 1, wherein:
the memory array stores a mapping of previous erroneous readings to reference operating temperature readings that were approximated in response to the previous erroneous readings, and
the memory controller is further configured to:
identify a previous erroneous reading matching the current operating temperature reading and compute the synthetic operating temperature reading as to a reference operating temperature reading that is mapped to the matching previous erroneous reading.

7. A method of operating a memory device, the method comprising:
obtaining a current operating temperature reading from an internal sensor that provides operating temperature readings of the memory device;
determining a synthetic operating temperature reading based on prior operating temperature readings of the memory device when the current operating temperature reading corresponds to an invalid signal; and
in response to the synthetic operating temperature reading satisfying an operational threshold for acceptable operating temperature readings of the memory device, performing one or more memory operations on the memory device.

8. The method of claim 7, wherein:
a data buffer of the memory device stores a mapping of secondary operating temperature readings to primary operating temperature readings, and
the method further comprising:
obtaining a current secondary temperature reading of the memory device from the internal sensor; and
assigning the synthetic operating temperature reading to a primary operating temperature reading that is mapped to the current secondary temperature reading in the data buffer.

9. The memory device of claim 7, wherein:
a data buffer of the memory device is configured to store the prior operating temperature readings in an ordered sequence according to corresponding timestamps, and
the method further comprising:
determining an approximate operating temperature reading for the synthetic operating temperature reading by extrapolating the ordered sequence of prior operating temperature readings.

10. A memory device, comprising:
a memory array configured to store data; and
a memory controller operably coupled to the memory array and configured to:
obtain an operating temperature reading from a sensor external to the memory controller;
compute a synthetic operating temperature reading based on prior operating temperature readings when the current operating temperature reading corresponds to an invalid signal; and
perform memory operations according to the synthetic operating temperature reading instead of the operating temperature reading.

11. The memory device of claim 10, wherein:
the obtained operating temperature reading is a current reading representative a temperature of an environment surrounding the memory controller;
wherein the memory controller is further configured to:
track a sequence of n recent temperature readings prior to the current reading; and
compute the synthetic operating temperature according to the sequence of n recent temperature readings.

12. The memory device of claim 11, wherein the synthetic operating temperature is computed based on extrapolating a pattern from the sequence of n recent temperature readings.

13. The memory device of claim 12, wherein the synthetic operating temperature is extrapolated according to a linear pattern.

14. The memory device of claim 11, wherein the controller is configured to:
determine that the obtained operating temperature reading is absent from a historical buffer configured to track previously obtained readings corresponding to the invalid signal;
compute the synthetic operating temperature reading based on determining the absence; and
store the obtained operating temperature and the reading as a pair of related values.

15. The memory device of claim 14, wherein:
the operating temperature reading is an initial invalid reading;
the memory controller is further configured to:
determine that a subsequent temperature reading also corresponds to the invalid signal, and compute synthetic operating temperature, wherein the subsequent temperature reading represents the temperature of the surrounding environment after the initial invalid reading;
identify that the subsequent temperature reading matches the initial invalid reading; and
based on identifying that the readings match, obtain the stored synthetic operating temperature that was previously computed for the initial invalid reading.

16. The memory device of claim 10, wherein:
the memory controller further includes a chip-internal sensor; and
the memory controller is further configured to compute the synthetic operating temperature according to an output form the chip-internal sensor in addition to the prior operating temperature readings.

17. The memory device of claim 16, wherein:
the obtained operating temperature reading represents an output from a sensor located on a printed circuit board (PCB) having the memory controller mounted thereon; and
the chip-internal sensor includes a system-on-chip (SOC) internal temperature sensor.

18. The memory device of claim 10, wherein the memory controller is further configured to determine that the obtained operating temperature reading exceeds a predetermined threshold corresponding to an upper end of an operating temperature range or a higher value established to detect (1) an output of a malfunctioning sensor or (2) a corrupted output that has been changed due to system noise.

19. The memory device of claim 18, wherein the memory controller is configured to continue memory operations according to the computed synthetic operating temperature instead of performing a failure response associated with exceeding the predetermined threshold.

20. The memory device of claim 10, wherein the memory device is a NAND memory device.
